(19) United States
(12) Patent Application Publication
(10) Pub. No.: US 2024/0325919 A1
(43) Pub. Date: Oct. 3, 2024

(54) SYSTEMS AND METHODS FOR COLLABORATIVE CREATING AND EDITING OF COMPUTER-GENERATED CONTENT

(71) Applicant: Electronic Arts Inc., Redwood City, CA (US)

(72) Inventors: Stephen Roger Kestell, Vancouver (CA); Richard Joseph Stringfellow, Bowen Island (CA)

(21) Appl. No.: 18/193,566

(22) Filed: Mar. 30, 2023

(51) Int. Cl. A63F 13/60; G06F 16/176; G06F 16/188

(52) U.S. Cl. CPC A63F 13/60; G06F 16/1774; G06F 16/188

(57) ABSTRACT

Embodiments of the present application provide an interactive computing system with a game development server that can host multiple game editing sessions and allow multiple game developer systems to work on the same game assets at the same time. The game development server can manage some or all change requests from game developers to make changes to the game data.

### BACKGROUND

Collaborative creation is an increasingly demanded aspect of video game development. Video game development is typically performed serially with an individual game developer working on game data and saving the work before another game developer can make changes to the game data. Accordingly, collaboration is difficult and game development is prone to delays. Providing a collaborative video game development space is a challenge due to the large size and complexity of the data and the sophistication of development tools.

### SUMMARY OF THE INVENTION

The systems, methods, and devices of this disclosure each have several innovative aspects, no single one of which ss solely responsible for all of the desirable attributes disclosed herein.

One embodiment discloses a method for collaboratively editing game data of a game application within a virtual development space, the method including: receiving a request from a user computing system to initiate an editing session; creating an instantiated virtual development space, wherein the instantiated virtual development space enables a first plurality of game developer systems to view and edit game data, and wherein the game data is stored on a server; receiving a request from a first game developer system of the first plurality of game developer systems to edit a first set of game data, wherein the first set of game data is a temporary instantiation of a subset of the game data; locking the subset of the game data in the server; receiving one or more changes by the first game developer system to the first set of game data; generating a log tracking the one or more changes to the first set of game data; broadcasting the one or more changes to the first set of game data within the instantiated virtual development space such that updates of the first set of game data are visible to the first plurality of game developer systems; receiving a change confirmation by the first game developer system for the one or more changes resulting in a confirmed change to the first set of game data; updating the subset of the game data in the server such that the subset of the game data in the server includes the confirmed change to the first set of game data; and unlocking the subset of the game data in the server.

Various embodiments of the method may include one, all, or any combination of the following features. In some embodiments, the method further includes receiving a request from a second user computing system to initiate a second editing session; and creating a second instantiated virtual development space, wherein the second instantiated virtual development space enables a second plurality of game developer systems to view and edit the game data. In some embodiments, the method further includes, in response to locking the subset of the game data in the server, preventing the second plurality of game developer systems from requesting to edit a second set of game data, wherein the second set of game data is a temporary instantiation of the subset of the game data. In some embodiments, the method further includes, in response to unlocking the subset of the game data in the server, broadcasting the one or more changes to the first set of game data within the second instantiated virtual development space such that the confirmed change to the first set of game data is visible to the second plurality of game developer systems. In some embodiments, the first game developer system receives permission from the server prior to making a request to edit the first set of game data. In some embodiments, creating the instantiated virtual development space includes delivering one or more data editing tools to the first plurality of game developer systems, wherein the one or more editing tools are configured to enable the first plurality of game developer systems to view and edit the game data. In some embodiments, in response to locking the subset of the game data in the server, a second game developer system of the first plurality of game developer systems is prevented from editing the first set of game data. In some embodiments, the method further includes receiving permission from the first game developer system to allow the second game developer system to edit the first set of game data.

Another embodiment discloses a system for collaboratively editing game data of a game application within a virtual development space, the system including: one or more processors configured with computer executable instructions that configure the one or more processors to: receive a request from a user computing system to initiate an editing session; create an instantiated virtual development space, wherein the instantiated virtual development space enables a first plurality of game developer systems to view and edit game data, and wherein the game data is stored on a server; receive a request from a first game developer system of the first plurality of game developer systems to edit a first set of game data, wherein the first set of game data is a temporary instantiation of a subset of the game data; lock the subset of the game data in the server; receive one or more changes by the first game developer system to the first set of game data; generate a log tracking the one or more changes to the first set of game data; broadcast the one or more changes to the first set of game data within the instantiated virtual development space such that updates of the first set of game data are visible to the first plurality of game developer systems; receive a change confirmation by the first game developer system for the one or more changes resulting in a confirmed change to the first set of game data; update the subset of the game data in the server such that the subset of the game data in the server includes the confirmed change to the first set of game data; and unlock the subset of the game data in the server.

Various embodiments of the system may include one, all, or any combination of the following features. In some embodiments, the one or more processors are further configured to: receive a request from a second user computing system to initiate a second editing session; and create a second instantiated virtual development space, wherein the second instantiated virtual development space enables a second plurality of game developer systems to view and edit the game data. In some embodiments, the one or more processors are further configured to: in response to locking the subset of the game data in the server, prevent the second plurality of game developer systems from requesting to edit a second set of game data, wherein the second set of game data is a temporary instantiation of the subset of the game data. In some embodiments, the one or more processors are further configured to: in response to unlocking the subset of the game data in the server, broadcast the one or more changes to the first set of game data within the second instantiated virtual development space such that the confirmed change to the first set of game data is visible to the second plurality of game developer systems. In some embodiments, the first game developer system receives permission from the server prior to making a request to edit the first set of game data. In some embodiments, the one or more processors are further configured to create the instantiated virtual development space includes delivering one or more data editing tools to the first plurality of game developer systems, wherein the one or more editing tools are configured to enable the first plurality of game developer systems to view and edit the game data.

Another embodiment discloses non-transitory computer readable medium including computer-executable instructions for collaboratively editing game data of a game application within a virtual development space that, when executed by at least one processor of a computing system, causes the computing system to: receive a request from a user computing system to initiate an editing session; create an instantiated virtual development space, wherein the instantiated virtual development space enables a first plurality of game developer systems to view and edit game data, and wherein the game data is stored on a server; receive a request from a first game developer system of the first plurality of game developer systems to edit a first set of game data, wherein the first set of game data is a temporary instantiation of a subset of the game data; lock the subset of the game data in the server; receive one or more changes by the first game developer system to the first set of game data; generate a log tracking the one or more changes to the first set of game data; broadcast the one or more changes to the first set of game data within the instantiated virtual development space such that updates of the first set of game data are visible to the first plurality of game developer systems; receive a change confirmation by the first game developer system for the one or more changes resulting in a confirmed change to the first set of game data; update the subset of the game data in the server such that the subset of the game data in the server includes the confirmed change to the first set of game data; and unlock the subset of the game data in the server.

Various embodiments of the non-transitory computer readable medium may include one, all, or any combination of the following features. In some embodiments, the computing system is further configured to: receive a request from a second user computing system to initiate a second editing session; and create a second instantiated virtual development space, wherein the second instantiated virtual development space enables a second plurality of game developer systems to view and edit the game data. In some embodiments, the computing system is further configured to: in response to locking the subset of the game data in the server, prevent the second plurality of game developer systems from requesting to edit a second set of game data, wherein the second set of game data is a temporary instantiation of the subset of the game data. In some embodiments, the computing system is further configured to: in response to unlocking the subset of the game data in the server, broadcast the one or more changes to the first set of game data within the second instantiated virtual development space such that the confirmed change to the first set of game data is visible to the second plurality of game developer systems. In some embodiments, in response to locking the subset of the game data in the server, a second game developer system of the first plurality of game developer systems is prevented from editing the first set of game data. In some embodiments, the computing system is further configured to receive permission from the first game developer system to allow the second game developer system to edit the first set of game data.

Although certain embodiments and examples are disclosed herein, inventive subject matter extends beyond the examples in the specifically disclosed embodiments to other alternative embodiments and/or uses, and to modifications and equivalents thereof.

### BRIEF DESCRIPTION OF THE DRAWINGS

Throughout the drawings, reference numbers are re-used to indicate correspondence between referenced elements. The drawings are provided to illustrate embodiments of the subject matter described herein and not to limit the scope thereof.

FIG. 1A-1C illustrate embodiments of a computing environment that can implement one or more embodiments of collaborative editing of video game data.

FIG. 2 illustrates an embodiment of a virtual environment data log.

FIG. 3A-3B provide embodiments of a single editor session.

FIG. 4A-4B illustrate embodiments of multiple editor session editing the same game application.

FIG. 5 illustrates an embodiment of a flowchart process for editing game data using an interactive computing system.

FIG. 6 illustrates an embodiment of a flowchart process for editing game data using a game editor client of a user computing system.

FIG. 7 illustrates an embodiment of a user computing system.

### DETAILED DESCRIPTION

### Overview

Video game development is typically performed in serial fashion, where one game developer creates and/or modifies game data and saves any changes. Then, another game developer loads the created or modified game data to perform further modifications. Parallel game development is typically performed in isolation with each game developer working on a separate portion of game data. The game data may be hundreds of gigabytes of data. As such, the serial fashion of game development can result in delays while large portions of the game data are tied to the task of one game developer. Collaborative game development may involve allowing more than one game developer to create or modify game data in the same development space, for example, a virtual development space. One challenge of collaborative development is that video game development may often have many game developers working on the same game data. When this is the case, it may be computationally expensive to include all the game developers in the same development space. As such, one set of game developers may still expend a significant amount of time waiting for game data to become available. Additionally, it can be difficult for both developers to be working on the same game asset simultaneously.

Embodiments of the present application provide solutions to these problems by using an interactive computing system with a game development server that can host multiple game editing sessions and allow multiple game developer systems to work on the same game assets at the same time. The game development server can manage some or all change requests from game developers to make changes to the game data. For example, game developers connected to an online game editing session, through a game development server, may make a change to a portion of the game data. The game development server may execute the requested changes to the game data. Additionally, the game development server may update the game data in all hosted game editing sessions. In this way, each requested change may be propagated through a build pipeline, and a cache of the build results can be stored with a unique identifier in the game data.

In some embodiments, game developers connected to the same game editing sessions can receive the same cached build results from the build pipeline, which can allow for simultaneous updates for the plurality of game developers working together within the same game editing session. In some embodiments, a temporary instantiation of all or a portion of the game data for one or more game assets may be associated with each game editing session. In this example, the game developers can be connected to the same game editing session and can receive the same cached build results from a build pipeline associated with the temporary instantiation. This can allow for simultaneous editing and updates for the plurality of game developers working together within the same game editing session. This way, multiple game developers may collaborate while editing temporary game data and confirm final changes to the game data at the end of the game editing session. The game development server can provide user interface controls for the game developers and/or can facilitate change requests from some or all connected game developers.

In some embodiments, the game development server can track when a portion of the game data is being edited and propagate to all game editing sessions that the portion of the game data is being edited. In some embodiments, the game development server can lock a portion of game data that is being edited in one game editing session, so the portion of game data is unavailable for changes in all other game editing sessions.

Advantageously, multiple game developers can assist each other in making modifications to an instantiation of game data, such as to a particular game asset within a virtual game development space, while preventing changes to the game data in other game editing sessions. In such an example, once the multiple game developers confirm a finalized modification to the instantiation of game data, the modifications may be applied to the game data stored on the game development server and propagated to all instantiations of the game data in other concurrent game editing sessions.

In some embodiments, a game editing session may take place in a virtual game development environment. In one example, each game developer is associated with an avatar within the virtual game development environment. Each avatar may indicate the area of the virtual game development environment the game developer is modifying. The game development server may generate an indication of a selection of a virtual object and broadcast the selection to other developers, showing the intent of the game developer to make a modification on a virtual projection of game data. For example, the location of the avatar of the game developers, the selection of virtual content, and the modifications performed on the virtual content may be broadcasted to other game developers connected to the virtual game development environment. In this example, the avatars can bring remote developers into a close virtual proximity creating a collaborative environment, as if the developers were in a meeting room working together. The game development server can receive modification requests, execute appropriate actions, and triggers a build system that caches the results in the temporary instantiation of game data to be presented to multiple runtime game developer systems connected to the game editing session.

The present disclosure describes embodiments with respect to video game development. However, the embodiments present application can be used in the development of any computer-generated content. As such, any specific reference to video game development, such as references to game data, game assets, or the like, can generally refer to assets and data associated with computer-generated content development. For example, game data may generally refer to any computer-generated content, game assets may generally refer to assets for computer-generated content, a game development server can generally refer to any server used for computer-generated content, and so on.

The details, including optional details, of one or more embodiments of the subject matter of this specification are set forth in the accompanying drawings and the description below. Other optional features, aspects, and advantages of the subject matter will become apparent from the description, the drawings, and the claims.

### Overview of Video Game Environment

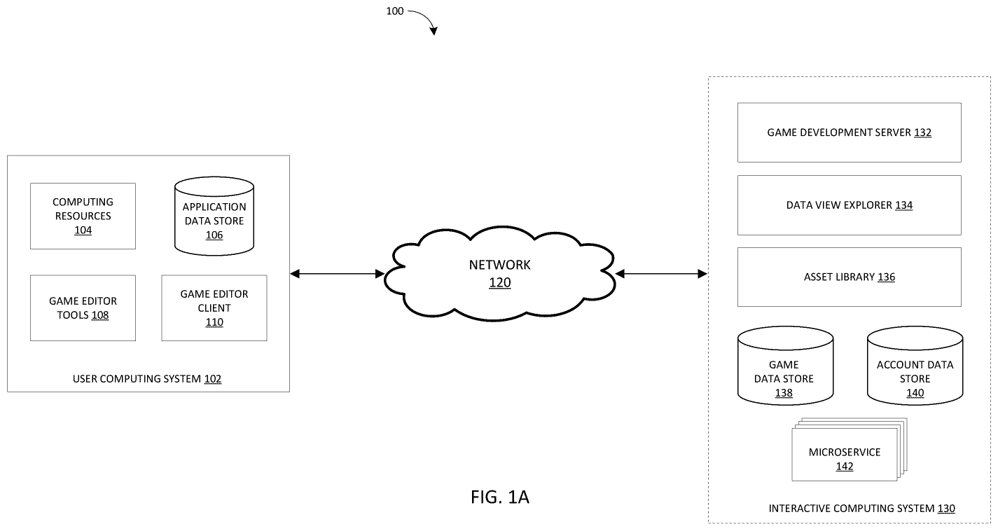

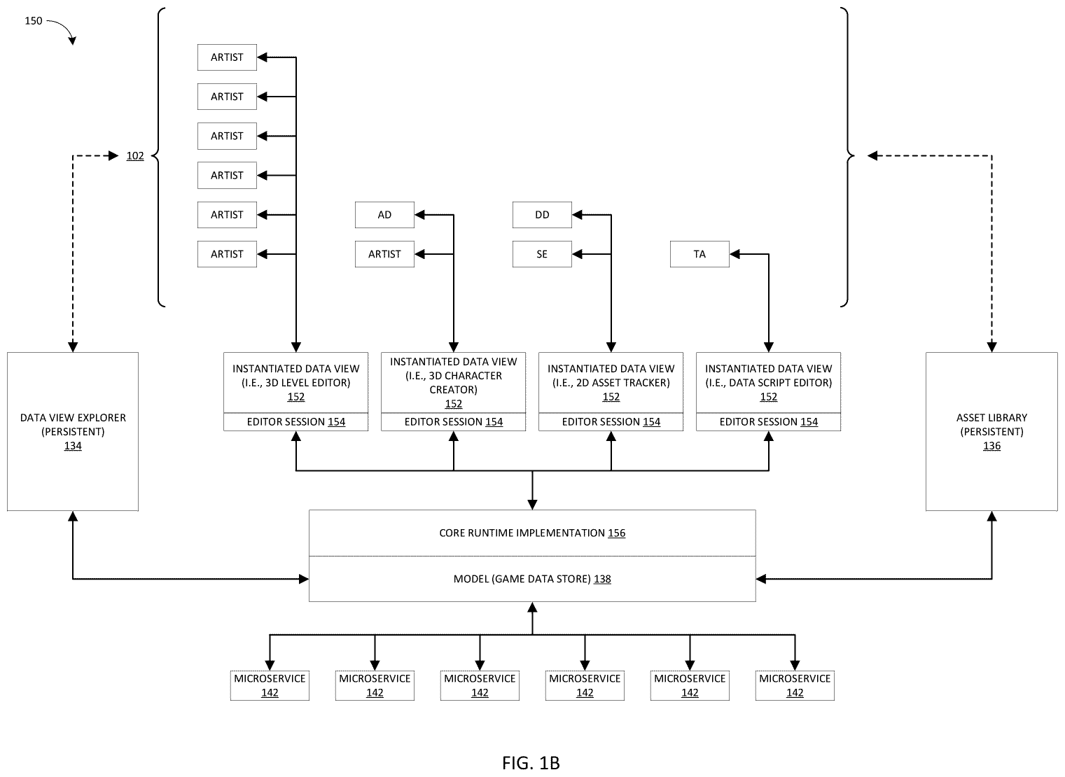

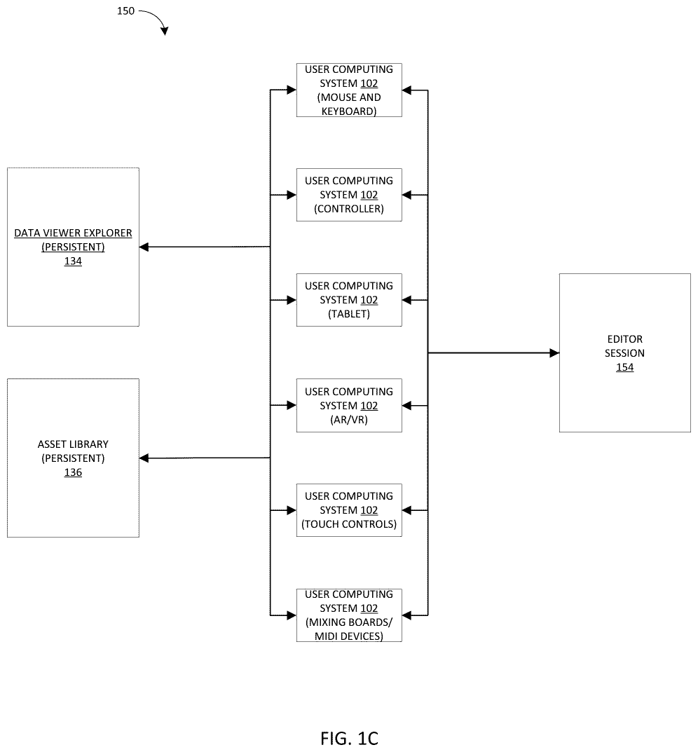

FIG. 1A illustrates an embodiment of a computing environment 100 for implementing a game editor client 110. The environment 100 includes a network 120, a plurality of user computing systems 102, and an interactive computing system 130, which includes a game development server 132, a data view explorer 134, an asset library 136, a game data store 138, an account data store 140 and a plurality of microservices 142. To simplify discussion and not to limit the present disclosure, FIG. 1A illustrates only one user computing system 102 and one interactive computing system 130, though multiple systems and servers may be used. The user computing system 102 may communicate via a network 120 with the interactive computing system 130. Although only one network 120 is illustrated, multiple distinct and/or distributed networks 120 may exist. The network 120 can include any type of communication network. For example, the network 120 can include one or more of a wide area network (WAN), a local area network (LAN), a cellular network, an ad hoc network, a satellite network, a wired network, a wireless network, and so forth. In some embodiments, the network 120 can include the Internet.

### A) User Computing Systems

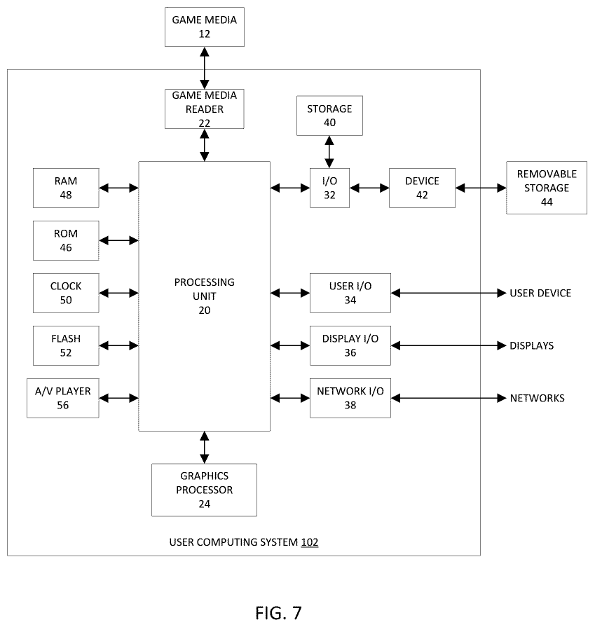

FIG. 1A illustrates exemplary user computing systems 102 associated with one or more game developers. A user computing system 102 may include hardware and software components for establishing communications over a communication network 120. For example, the user computing system 102 may be equipped with networking equipment and network software applications (for example, a web browser) that facilitate communications via one or more networks (for example, the Internet or an intranet). The user computing system 102 may have varied local computing resources 104 such as central processing units (CPU) and architectures, memory, mass storage, graphics processing units (GPU), communication network availability and bandwidth, and so forth. Further, the user computing system 102 may include any type of computing system. For example, the user computing system 102 may include any type of computing device(s), such as desktops, laptops, video game platforms, television set-top boxes, televisions (for example, Internet TVs), network-enabled kiosks, car-console devices computerized appliances, wearable devices (for example, smart watches and glasses with computing functionality), and wireless mobile devices (for example, smart phones, PDAs, tablets, or the like), to name a few. The specific hardware and software components of the user computing system 102, are referred to generally as computing resources 104. In some embodiments, the user computing system 102 may include one or more of the embodiments described below with respect to FIG. 7.

The user computing system 102 may include a game editor client 110 (also referred to as a game development client or a dynamic development client). The user computing system 102 may include game editor tools 108. The user computing system 102 may execute a game editor client 110 and/or game editor tools based on software code stored at least in part in the application data store 106. In some embodiments, the application data store 106 may store software code associated with a game application, also referred to as a videogame, a game, game code and/or a game program. In some embodiments, the application data store 106 may receive game data to store from the interactive computing system 130 via the network 120.

### 1. Game Editor Client

The game editor client 110 provides an interface for the user to modify a game application, such as an existing game application or a game application in development. In some embodiments, the game editor client 110 may include user account interface that requires the user to login or create a user account in order to access the game development functionality of the interactive computing system 130. The game editor client 110 can be dynamically configured based on the type of user computing system 102 that is executing the game editor client 110. The game editor client 110 can generate a computing profile of the user computing system 102 in order to determine the types of game editor tools 108 that can be used by the user computing system 102. The computing profile can also determine the types of game assets that can be modified by the user computing system 102. The game editor client 110 can have different interfaces based on the type of computing system that is executing the game editor client 110.

Different computing devices can have access to different types of game editor tools 108. For example, a smart phone can have different editing functionality than a tablet, laptop or desktop computing device. Each computing device has different computing resources and can have different types of game editor tools 108 that can function appropriately on the computing device. In some embodiments, the computing device can be a virtual reality system. The game editor client 110 can use the computing profile to identify a subset of the game editor tools 108 that are available to the user computing system 102. A user computing system 102 may not have access to all the game editor tools 108 available. For example, a desktop may not have access to tools that are specific to execution within a mobile computing environment, such as a smart phone.

The game editor client 110 can provide a list of options of tools that are available to the user. The list of options may allow the user to select tools based on the type of modification that the user would like to perform on the game application. The user may utilize less than all the tools available to a particular computing device. The game editor client 110 may identify game editor tools 108 that are available for download by the user, game editor tools 108 that are available for streaming by the user, and/or game editor tools 108 that have been previously installed on the user computing system.

For game editor tools 108 that are available for download, the game editor client 110 can provide access to the game editor tools 108 to be installed locally in volatile or non-volatile memory on the user computing system. The game editor client 110 may operate like a host client application that controls access to game editor tools 108 that are installed on the user computing system. The game editor client 110 may have access restrictions that prevent installed game editor tools 108 from being used for other purposes or with assets that are not approved. For example, the game editor client 110 may require that any assets modified or created using the tool are saved in a network-based data store (e.g., game data store 138) and prevent the user from saving assets locally on the user computing system 102.

In some embodiments, a game editor tool 108 may be executed on a remote server (e.g., the interactive computing system 130) and the game editor client 110 may stream the execution of the game editor tool 108 to the user computing system. The game editor client 110 can provide a user interface for the remotely executed game editor tool 108. The availability of a game editor tool 108 for streaming may be based on the computing profile of the user computing system, requirements associated with the game editor tool 108, and/or the requirements associated with the game application.

In some instances, the game editor tools 108 that are available to a particular user may be based on the software that has been previously installed by the user on the computing system. For example, some game editor tools 108 may require a license in order to utilize the tools. The game editor client 110 can be configured to interface directly with these tools (such as through an extension installed on the tool) or may be configured to launch the tool on the user computing system, among other interactions. For example, the game editor client 110 may be configured to provide for the game editor tool 108 to access the game assets from the asset library 136.

In some embodiments, the game editor client 110 may be associated with a permission level. A permission level may restrict the user from using certain game editor tools 108, from making changes to specific game data in the game data store 138, and/or from accessing or modifying content from the asset library 136.

The game editor client 110 can provide an interface through which the user can access the asset library 136. The asset library 136 provides access to game assets that a user can modify. The game assets access can be divided into various different categories, such as public and private game assets. Private game assets may include assets that are not available to a user and cannot be modified by the user. In some embodiments, the user may only be provided with a view of the game assets that are available for modification by the user. In some embodiments, the user may be able to see a listing of game assets that are not available for modification. This can help the user to know what modification that the user can make to the game application. Some game assets may have different types of restrictions based on the type or importance of asset. For example, some assets may be available for modification, but may not be downloaded locally on the user computing system for offline use of the asset by the user. This can help to prevent the unauthorized use of assets outside of game editor client 110. Based on the computing profile, game editor tool 108 requirements, game application requirements, and the user permission level, the interactive computing system 130 can determine the game editor tools 108 that are available to the user computing system 102, the game applications that are available to the user computing system 102, and the game assets that can be accessed and/or modified by the user computing system 102.

### 2. Game Editor Tools

Generally, game editor tools 108 (also referred to as game development tools) can be any commercially available tool, developer specific tool, and/or game application specific tool that can be used to create or modify data associated with all levels of game development. For example, the game editor tools 108 may be tools configured to create or modify a game engine. The game editor tools 108 may be tools configured to modify the game data of a game application. For example, a user may use the game editor tools 108 to add or remove an asset from a game application. The game editor tools 108 may be used to create or modify assets used across multiple game applications. For example, a user may use the game editor tools 108 to edit a texture package used in multiple game applications. The game editor tools 108 may be used to create or modify other game editor tools to be used in game development. For example, the game editor tools 108 may be configured to allow a game developer to build a new tool to modify game data that is specialized to a specific task.

The game editor tools 108 can refer to proprietary tools created or used by the developer, commercially available tools, extensions to commercially available tools, and/or other types of software applications that can be used to modify or create game assets for a game application or to modify or create game applications themselves. For example, interactive computing system 130 may have a specific engine that is used to build the game application. The developer game editor tools 108 may include game application specific tools that can be used to modify the game assets within the game. The game editor tools 108 may include the engine and other tools that the user can use to interface with the game assets of a game application. The game editor tools 108 can refer to commercial game development programs such as 3ds Max, Adobe Substance, Maya, Z-brush, Visual Studio, Blender, and other tools that are used. The tools may be locally installed on the user computing system 102 or may be installed on the interactive computing system 130 and available for streaming to the user computing system 102.

### B) Interactive Computing Systems

The interactive computing system 130 may include a game development server 132, a data view explorer 134, an asset library 136, a game data store 138, an account data store 140, and one or more microservices 142. The interactive computing system 130 may be configured to host execution of one or more game editor tools 108 for use by the user computing systems 102. In some embodiments, the interactive computing system 130 can include one or more computing devices, such as servers and databases that may host and/or execute a portion of one or more instances of the game editor tools 108 and a game update distribution system. The interactive computing system 130 can be configured to interface with the game editor client 110 executing on user computing systems 102 and provide for the creation and/or modification of game applications.

### 1. Game Data Store

The game data store 138 can store game data associated for a game application. For each game application, the game data can be divided between public game data and private game data. Public game data can include the data and game assets that are available for use and/or modification by all users. The game data store 138 may be the same game data store 138 used by internal developers to access game data of the game application. The public game data can be accessed (e.g., via download) and are available for the user to use and/or modify. The private game data can include the data and assets that have been designated as private and cannot be modified by all users. In some embodiments, a user may have read access to a private asset. In some instances, the private game data can be edited by a user that has a secure connection to the interactive computing system 130, such as a developer computing system interfacing with the game assets through a VPN connection or through an internal connection within a game development studio (e.g., intranet). The private game data may be game data and game assets that are related to aspects of the game application that the developer does not want to be made available disclose to the public for modification or review (e.g., source code of a game engine or rendering engine). The user may have access to game assets, such as code that defines game affecting gameplay, but may have restrictions preventing access to designated models within the code. Each game application can define its own access parameters that define public and private game data. In some instances, the game data may not have any private game data and all the game data may be categorized as public game data. In some instances, a user may have a permission associated with the user that designates which game data is public to the user and which game data is private to the user. The data stored in the game data store 138 may be queried, created and/or modified directly through an application programming interface (API). In some instances, a user of an API may have a permission associated with the user that designates which data in the game data store 138 is available to query, create, and/or modify through the API.

The data stored in the game data store 138 may have dependencies. The game data store 138 may have a framework that allows for the identification of dependencies between different assets within the game data store 138. The game data store 138 may account for and/or track any dependencies of the data stored in the game data store 138. For example, the game data store 138 may include a first asset that that is dependent upon data from one or more other assets, such as a second asset and/or a third asset.

### 2. User Account Data Store

The interactive computing system 130 can include one or more account data stores 140 that are configured to store user account information associated with user computing systems 102. A user account data store 140 can be configured to store permissions associated with a user account. For example, the user account data store 140 may store information related to which game applications the user has permission to use and/or which assets the user has permission to modify.

### 3. Asset Library

The asset library 136 can manage and control user access to game assets. A game asset may be a package of data used to define an element of game data. A game asset may be specific to a particular game application or may be a common element available for all game applications. For example, a specific character may be a unique game asset for one game application, but the specific character may be a compilation of common game assets that are available and present in multiple game applications. The asset library 136 can track and manage what assets are available for a specific game application.

The asset library 136 may be specific to a game application. Alternatively, the asset library 136 may be universal for more than one game application. The asset library 136 can manage the distribution of game assets. For example, the asset library can manage the distribution of game assets to the game development server 132. The asset library 136 can include various management functions for managing assets for a user, such as version control, checking in/checking out assets, game asset versions, and other management functions. The asset library 136 can prevent multiple users from working simultaneously on the same game asset, or at least the same portions of an asset, some assets may provide for different aspects of the asset to be modified simultaneously. The asset library 136 can provide for a user to select an available asset, download a version of the asset, and then store the version of the asset. For example, the asset library 136 may allow a user to download a version of an asset and store the version on a user computing system 102. In another example, the asset library 136 may allow a user to store a version of an asset that is associated with a game application in the game data store 138.

### 4. Data View Explorer

The data view explorer 134 can provide a server-side management module that interfaces with the game editor client 110 of user computing systems 102 to organize and manage the game data and game assets of a game application. In one embodiments, the data view explorer 134 provides an overview of open editing sessions to the game editor client 110. In one embodiment, the data view explorer 134 provides an interface for a user computing system 102 to join an existing editing session or to create new editing sessions. The data view explorer 134 may only show editing sessions that a user has permission to join. Alternatively, the data view explorer 134 may show all editing session but indicate to the user which editing session the user does and does not have permission to join.

In some embodiments the data view explorer 134 can be customized to display different views of the game data and game assets of a game application as needed for a particular game development project. For example, the data view explorer 134 may be configured to display specific types of assets and data associated with a specific game application. In another example, the data view explorer 134 may be configured to show assets and data that are used by specific game development tools.

### 5. Game Development Server

The game development server 132 provides hardware and software tools that are configured to compile and host an editor session 154 (described in further detail with reference to FIG. 1B and FIG. 1C). The game development server 132 can manage aspects of the game development process, such as, for example, importing game assets stored in the asset library 136, exporting game assets to the asset library 136, generating application builds, generating and hosting game editing sessions, and other services. These various game development functionalities associated may be further handled by one or more microservices 142. The game development server 132 can be configured to create a data log tracking each modification to game data and store the data log in the game data store 138. The game development server 132 can be configured to present the data log to a user and revert a portion of game data to an earlier version when prompted by a user.

The game development server 132 can be configured to perform build actions in order to perform partial rebuilds of game data and assets that have changed by a user within an editing session. The game development server 132 can be used to identify the changes that have been made to the game data and assets. The game development server 132 can identify dependencies of new or modified game assets in order to update the game asset in the game data store 138. The game development server 132 may be configured to generate modular builds for larger editor sessions 154. The modules may be configured so that they can be independently compiled, which can significantly reduce the build time of the build process. The game development server 132 can be implemented using the resources of the interactive computing system 130. The microservices 142 can be used in all or part of the update and build process. For example, a microservice may handle compressing a texture to a game ready asset after it has been modified.

The game development server 132 can perform builds of the editing sessions 154, which can provide advantages for users over local builds. For example, in order to perform a build of an editing session, the user may be required to download the entire source code of the game application, which could be hundreds of gigabytes of data. Additionally, the user would have to compile all or a portion of the game application using the processing resources of the user's personal computing system, whereas, the game development server 132 can compile remotely using the resources of the interactive computing system 130 (or independent build servers) and utilize existing build modules and resources that already been compiled by the interactive computing system 130 for the editing session 154.

### Embodiment of Modifying a Game Application

FIG. 1B and FIG. 1C illustrate an embodiment of a computing environment 150 for modifying a game application. Computing environment 150 may include some or all of the features described with respect to FIG. 1A. Computing environment 150 may include a one or more user computing systems 102, and one or more components associated with an interactive computing system 130, such as a data view explorer 134, an asset library 136, one or more editor sessions 154, a core runtime implementation 156, a game data store 138 (also referred to as a model), and/or one or more microservices 142.

### A) Editor Sessions

An editor session 154 can be an instantiated data view 152 of some or all of the data of a game application. To compile an instantiated data view 152, the game development server 132 (e.g., the core runtime implementation 156) gathers data from the game data store 138 and from the user computing systems 102 and presents the data in an interface configured to view and edit the data. For example, an instantiated data view 152 may be a 3D level editor, a 3D character creator, and/or a 2D asset tracker through a virtual editing environment. An instantiated data view may also be a data script editor through an integrated development environment (IDE). An editor session 154 may allow a user to view and/or edit the data compiled in the instantiated data view 152. In some embodiments, the game development server 132 delivers one or more editing tools to allow a user to edit data. In some instances, a user may see representation of game data in the editor session 154 that cannot be edited by the user. The user may be prevented from editing a portion of game data due to a user in a different editor session 154 editing the same portion of game data. The user may also be prevented from editing a portion of game data due to a lack of permissions associated with the user's account or because the user is not connected through authorized server connections. Other examples may also prevent the user from editing a portion of game data, including the data is tagged as private, the user is not connected through a particular form of instantiated data view, and other techniques for preventing game data from being edited.

The changes to game data performed in an editor session may be propagated to other users joined to the editing session. For example, a user may make preliminary changes to a portion of game data in an editing session. The core runtime implementation 156 may cache those preliminary changes to the portion of game data and broadcast the preliminary changes by building the cache into the instantiated data view 152 of the editor session 154. In this example, the preliminary changes may be visible to the users connected to the editing session may such that the users can see the preliminary changes and provide feedback in real time to each other prior to saving the changes to the server and unlocking the game data for modification by other users. When a desired final change to the game data is reached, a user may commit the changes, causing the core runtime implementation 156 to store a log of the change and update the portion of game data in the game data store 138.

In some embodiments, a data log of the temporary changes occurring in an editor session is stored in the game data store 138. A user may use the data log to revert one or more changes to the game data made during an editor session 154 back to an earlier version of the game data. A user may save an editor session 154. For example, a user may cause the core runtime implementation 156 to store a state of a given editor session 154 in the game data store 138. A user may save an editor session 154 without committing the changes. A user saving an editor session 154 allows an editor session 154 to be closed and re-instantiated without losing unfinished work.

In some embodiments, a user can be connected to multiple editor sessions 154 concurrently. The user may be able to alternate between which editor session 154 the user is viewing. The user may be able to view two or more editor sessions 154 simultaneously. The user may be able view the same portion of game data represented in multiple instantiated views of the game data.

In some embodiments, a user may open an editor session 154 in a test mode or read-only mode. The test mode may allow a user experiment with various changes to game data. In the test mode, the editor session 154 may not lock data in a server or commit changes back to the server. In some embodiments, an editor session 154 in a test mode has no locked data.

### 1. Locked Data

Multiple editor sessions 154 can be open to view and edit the same game data. Portions of the game data may be locked within the editor sessions 154. For example, a user editing a portion of game data (e.g., a tree) in one editor session 154 may lock the tree from being edited by users in other concurrent editor sessions 154 that host the same game data. An indication of locked portions may appear in the editor session 154. For example, a tree that is locked in an editor session 154 may have a graphical indication that the tree is locked. Alternatively, a message may be displayed to a user who tries to edit a locked portion of game data. Locked game data may be in a frozen state while locked. For example, game assets that are locked may be frozen in the state the game asset was in prior to initiating the edits. Locked game data may update to a completed state once the game data has been unlocked. For example, a tree that is being edited in a different editor session 154 may appear in a frozen state until it is unlocked. Once the tree is unlocked, the tree may be updated to a new version (e.g., the tree appears different once it has been unlocked). By freezing the state of locked data, computing resources dedicated to an editor session may be preserved. For example, a game development server 132 (e.g., the core runtime implementation 156) may not need to spend computing resources propagating updates for game assets that are not available for editing in a particular editing session 154.

### 2. Partitioning

An editor session 154 may be partitioned into one or more subdivisions of game data. A subdivision of game data may include one or more portions of game data such as game assets and portions of game code. A subdivision may be defined by permission levels of the various users connected in an editing session. A subdivision may also be user selected. For example, a user may select a portion of data to edit, causing the game development server 132 (e.g., the core runtime implementation 156) to partition the selected portion into a subdivision of game data. Multiple users may have permission to edit a subdivision of game data, for example the user that selected the partition may have control to allow other users to edit data within the partition. In some embodiments, a user's edit permissions can be controlled by the permissions associated with a user account.

A subdivision of game data may be locked in the game data store 138. In one example, when a user partitions a portion of data to edit, the subdivision can be locked to other editor sessions 154 until the user commits the changes or otherwise releases the data. In an embodiment, locked data due to partitioning can be frozen only in editor sessions 154 that are separate from the editor session 154 where the partitioning took place. In such an embodiment, users in the same editor session 154 may view live updates of the temporary changes to the subdivision of game data, regardless of if the user has permission to edit data in the subdivision.

### 3. Game Editing Environment

A user computing system 102 may provide an interface through the game editor client 110 for the user to view, create, and/or modify game data through an editor session 154. An editor session 154 may require different forms depending on type of game data. For example, an editor session 154 designed to view and edit visual objects of a game may be different than an editor session 154 designed to view and edit the audio data files of a game. In one embodiment, the user computing system uses the game editor client 110 and game editor tools 108 to build an editor session 154 comprising a virtual environment. In another example, the game editor client 110 streams the editor session 154 comprising a virtual environment from interactive computing system 130. In another embodiment, an editor session 154 may be a nongraphical representation of game data such as an integrated development environment (IDE) configured to edit data script of the game data.

i. Virtual Environment

As used herein, a virtual environment may comprise a simulated environment (e.g., a virtual space) instanced on a user computing system 102, a server (e.g., the interactive computing system 130) that is accessible by a client (e.g., user computing system 102) located remotely from the server, to format a view of the virtual environment for display to a user of the client. The simulated environment may have a topography, express real-time interaction by the user, and/or include one or more objects positioned within the topography that are capable of locomotion within the topography. In some implementations, the topography may be a 2-dimensional topography. In other instances, the topography may be a 3-dimensional topography. In some implementations, the topography may be a single node. The topography may include dimensions of the virtual environment, and/or surface features of a surface or objects that are “native” to the virtual environment. In some implementations, the topography may describe a surface (e.g., a ground surface) that runs through at least a substantial portion of the virtual environment. In some implementations, the topography may describe a volume with one or more bodies positioned therein (e.g., a simulation of gravity-deprived space with one or more celestial bodies positioned therein). A virtual environment may include a virtual world, but this is not necessarily the case. For example, a virtual environment may include a game space that does not include one or more of the aspects generally associated with a virtual world (e.g., gravity, a landscape, etc.). By way of illustration, the well-known game Tetris may be formed as a two-dimensional topography in which bodies (e.g., the falling tetrominoes) move in accordance with predetermined parameters (e.g., falling at a predetermined speed, and shifting horizontally and/or rotating based on user interaction).

The game instance of the video game may comprise a simulated virtual environment, e.g., a virtual environment that is accessible by users via clients (e.g., user computing systems 102) that present the views of the virtual environment to a user. The virtual environment may have a topography, express ongoing real-time interaction by one or more users and/or include one or more objects positioned within the topography that are capable of locomotion within the topography. In some instances, the topography may include a two-dimensional topography. In other instances, the topography may include a three-dimensional topography. The topography may include dimensions of the space and/or surface features of a surface or objects that are “native” to the space. In some instances, the topography may describe a surface (e.g., a ground surface) that runs through at least a substantial portion of the space. In some instances, the topography may describe a volume with one or more bodies positioned therein (e.g., a simulation of gravity-deprived space with one or more celestial bodies positioned therein). The instance executed by the computer components may be synchronous, asynchronous, and/or semi-synchronous.

It should be understood that the above description of the manner in which state of the virtual environment associated with the video game is not intended to be limiting. The game application may be configured to express the virtual environment in a more limited, or richer, manner. For example, views determined for the video game representing the game state of the instance of the video game may be selected from a limited set of graphics depicting an occurrence in a given place within the video game. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the video game are contemplated.

### B) Editor Session Users

FIG. 1B illustrates a plurality of user computing systems 102 connected to editor sessions 154 (i.e., “users” of the editor session). It should be noted that more users 102 or fewer users 102 may be present in the computing environment 150. For example, computing environment 150 may occur with one user 102. A user 102 may be associated a role. For example, a user 102 may be associated with the role of artist, artistic director (AD), development director (DD), technical artist (TA), software engineer (SE) or any other role useful in video game development. Referring to FIG. 1C, a user computing system 102 may also be associated with a particular computing device.

### 1. User Roles

Referring again to FIG. 1B, the role of a user may change the permissions the user has. For example, a user 102 with the role of artist may have permissions to start or join an editor session associated with a 3D level editor instantiated data view 152 but not have the permission to start or join an editor session associated with a data script editor instantiated data view 152. In an embodiment, the role of a user may change permissions the user 102 has to edit certain data types. For example, a TA may have permission to edit a game asset associated with a physics engine while an artist may have permission to edit a game asset associated with a texture package. The role of a user may also change the ability to create and/or access subdivisions of data. For example, a user 102 with the role of AD may be able to access all subdivisions of data within an editor session 154 without permission from the user that created the partition. In some embodiments, the role of a user may restrict the user 102 from partitioning the data. For example, a user 102 with the role of artist may be unable to create subdivision of game data within an editor session 154. While specific user roles are depicted in FIG. 1B for illustrative purposes, different user roles may be present. Similarly, the illustrated user roles may be omitted. While user roles are depicted as associated with editor sessions 154, any user role may participate in any editor session 154 if the user has the requisite permissions, regardless of title or role. Some users 102 may have no associated role.

### 2. User Computing Devices

FIG. 1C illustrates a plurality of user computing systems 102 connected to an editor session 154, a data view explorer 134, and an asset library 136. It should be noted that more user computing systems 102 or fewer user computing systems 102 may be present in the computing environment 150. For example, computing environment 150 may occur with one user computing systems 102. A user computing system 102 may interface with an editor session 154 with one or more input devices. For example, a user computing system 102 may interface with the editor session 154 using a mouse and keyboard, a controller (e.g., a video game controller comprising buttons and analog sticks), a tablet computer, an augmented reality (AR) input/output, a virtual reality (VR) input/output, touch controls (e.g., from a mobile phone or dedicated kiosk), a mixing board/MIDI device, or any other input/output device useful in editing video game data.

In some embodiments, a role and/or permission associated with a user computing system 102 may be altered depending on the input the user computing system 102 is using to interface with the editor session 154. For example, a user computing system 102 associated with only a mixing board input may be restricted to joining edition sessions, viewing data, and/or editing data that is associated with audio game data. While FIG. 1C illustrates distinct interface input for each user computing system 102, a user computing system 102 may have more than one interface input or may change interface inputs. For example, a user computing system 102 may have both a mouse and keyboard input and a mixing board input. In this example, the user computing system 102 may have the permission to edit both audio and visual data based on the multiple inputs. In some embodiments, the interface input has no bearing on the permissions a user computing system 102 has. For example, a particular user computing system 102 may be restricted from editing audio game data, regardless of if a mixing board input is used.

### Embodiments of a Game Data Log

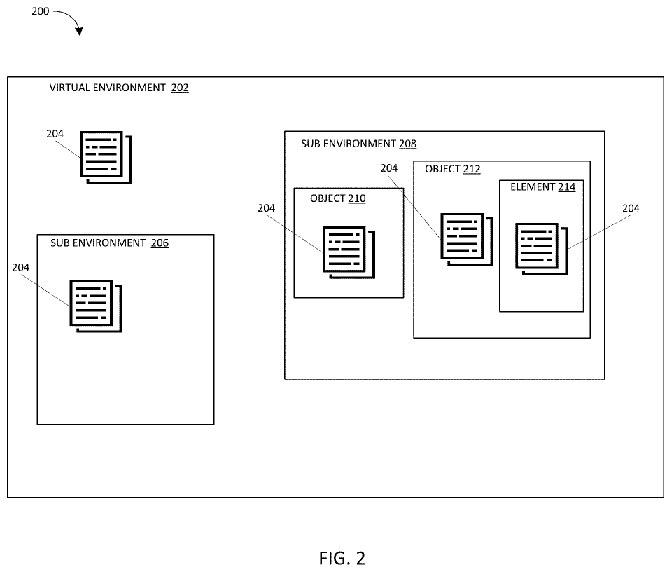

FIG. 2 illustrates an embodiment of a virtual environment data log 200. A virtual environment data log 200 may be associated with one or more editor sessions 154 as described with respect to FIG. 1B. A virtual environment data log 200 may comprise one or more datalogs 204. As described herein, a datalog 204 can record of actions and/or changes occurring within a game editor sessions and to the game data associated with the game assets. For example, a datalog 204 may catalog actions performed by users and changes to game data made during an editor session 154 (e.g., through a datalog associated with a virtual environment 202). The game data log may record changes to game data associated with a sub environment (e.g., through a datalog associated with a sub environment 206 and/or 202), a specific asset or object of game data (e.g., through a datalog associated with an object 210 and/or 212), and/or a game asset (e.g., through a datalog associated with an element 214). A datalog 204 may also catalog changes to other aspects or the game editing environment and/or other associated game data. In some embodiments, all assets stored in the game data store 138 are associated with at least one datalog 204.

A virtual environment data log may comprise a plurality of nested datalogs 204. For example, a virtual environment data log 200 may comprise a datalog 204 associated with a virtual environment 202. The datalog 204 associated with the virtual environment 202 may further comprise a datalog 204 associated with a first sub environment 206 and a datalog 204 associated with a second sub environment 202. The datalog 204 associated with a second sub environment 2062 may further comprise a datalog 204 associated with an object 210 and/or 212, and a datalog 204 associated with an element 214. The nested datalogs 204 may be stored and reviewed by a user, allowing a user to view an earlier state of a portion of game data and/or revert the portion of game data to the earlier state.

### Embodiments of a Game Editor Session

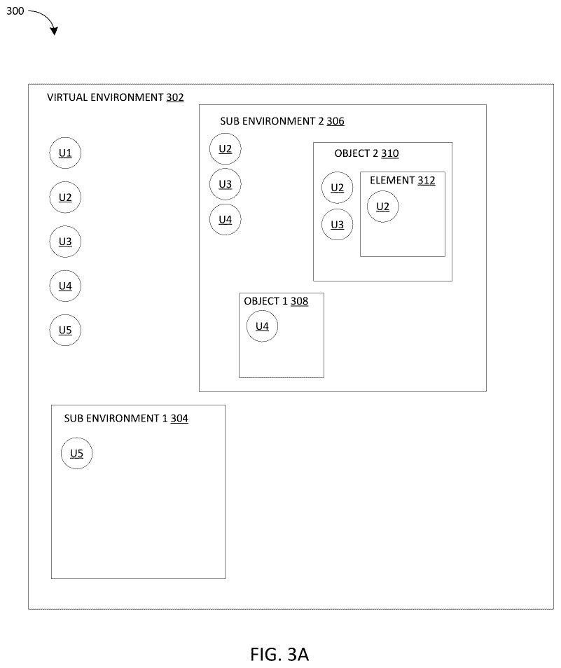

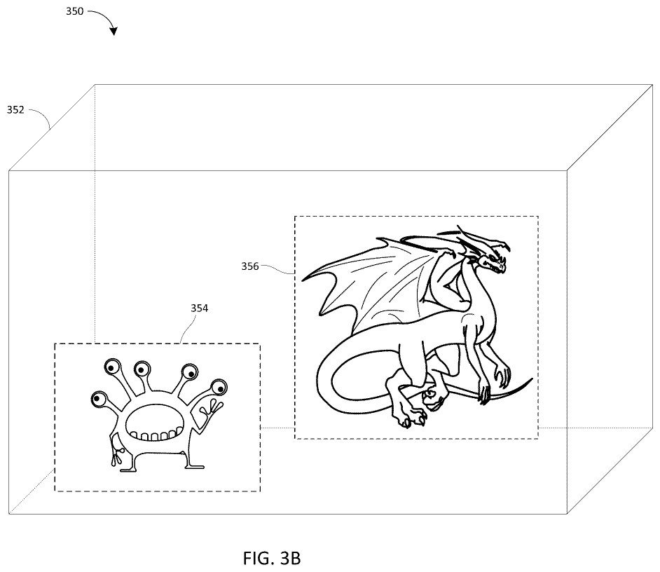

FIG. 3A and FIG. 3B illustrate embodiments of an instantiation of an editor session 300. Referring to FIG. 3A, editor session 300 illustrates a graphical representation of game data partitioning and user roles described earlier with reference to FIG. 1A and FIG. 1B. Editor session 300 may include a virtual environment 302, sub environments 304 and 306, objects 308 and 310, and element 312. Virtual environment 302, sub environments 304 and 306, objects 308 and 310, and element 312 are to be understood as individual game assets and/or portions or groups of game data associated with a game application and/or game asset. Virtual environment 302 may contain partitioned and hierarchal data. For example, sub environments 304 and 306 may comprise all, or part of the game data associated with virtual environment 302. Similarly, objects 308 and 310 may comprise all, or part of the game data associated with sub environment 306. Element 312 may comprise part of the game data associated with object 310.

FIG. 3A illustrates a plurality of users U1-U5. The permissions of each user U1-U5 is illustrated by which partition a user appears in. For example, user U2 appears in virtual environment 302, sub environment 306, object 310, and element 312. Therefore, user U2 has the permission to edit game data in virtual environment 302, sub environment 306, object 310, and element 312, but does not have the permission to edit the game data in sub environment 304 or object 308. Similarly, user U1 only appears in virtual environment 302. As such, user U1 may only edit data that is not in sub environments 304 or 306. In the illustrated example, no game data is shown that is not in sub environments 304 or 306. This may indicate that user U1 is in a non-editing role. For example, user U1 may be in a supervisory role and therefore only needs to view the changes to the game data. In an alternate example, virtual environment 302 may contain game data that is not in sub environments 304 or 306 that user U1 has permission to edit. While the illustrative embodiment shows a specific configuration of the virtual environment 302, other configurations may exist. For example, virtual environment 302 may have more or less sub environments than is shown. Similarly, other configurations of user permissions may exist. For example, a user may have permission to edit multiple sub environments, such as sub environments 304 or 306, but not all the sub environments within a virtual environment 302.

Each user U1-U5 may receive live updates of game data changes that occurs within the editing session 300. For example, when user U5 makes changes to sub environment 304, the changes are cached and broadcast so that to the remaining users U1-U4. This provides the opportunity for users U1-U5 to collaborate while in editing session 300. For example, users U1-U4 can provide feedback to user U5 and/or make changes to other game data in virtual environment 302 before user U5 has committed the changes in sub environment 304. As such, the game development by users U1-U5 may happen in parallel rather than serially.

Referring to FIG. 3B, editor session 300 illustrates an example virtual environment 352 used to view and edit game data. In the illustrated example, virtual environment 352 comprises game data objects 354 and 356. Virtual environment 352 may also contain game data not specifically shown, such as game assets such as game physics or lighting, background animations such as sky simulation, etc. Editor session 300 may also contain one or more users. The one or more users may have avatars (not shown) associated with each user to help communicate which game data each user is editing. In some embodiments, users do not have avatars. In some embodiments, an indication, such as text, is associated with game data objects (e.g., objects 354 and 356) that informs the users that the object is being edited and identifies the user(s) editing the object. In some embodiments, the editor session 300 may not provide an indication of the tasks of each user.

Objects 354 and 356 may be comprised of multiple layers of game data. For example, object 354 may represent an alien character in a game application. Object 354 may be a compilation of different game assets such as audio modules, texture packages, animation rig modules, mesh modules and so on. Object 356 may represent a dragon character in the game application. Object 356 may be a compilation of game assets. Editor session 300 may track dependencies of game data. For example, editor session 300 may track that some game data is shared between objects 356 and 354. Editor session 300 may warn or otherwise make a user aware that changes in shared game data will affect multiple nodes of game data. For example, objects 354 and 356 may share some game assets. For example, objects 354 and 356 may share the same texture assets used for portions for their skin. Editing of a shared game asset on one of the game objects may cause both objects 354 and 356 to be locked, or portions of the shared game data may be locked. Objects 354 and 356 may also have unshared game data and game assets. For example, object 354 may have game data that cause object 354 to appear as an alien and object 356 may have game data that cause object 356 to appear as a dragon. Editing the unshared game data will only effect one of object 356 or object 354.

Changes to objects 354 and 356 may be cached and broadcast to all users in editor session 350. In an embodiment, one or more changes a user makes to object 354 may be broadcast to one or more users editing object 356. As such the users editing object 356 may provide comment or update object 356 in response to the changes to object 354. For example, a first user may change the size of object 354. A second user editing object 356 may provide feedback to the first user that the relative size of objects 354 and 356 is no longer desirable and/or change the size of object 356 to compensate for the changes in object 354.

### Embodiments of Multiple Editor Sessions

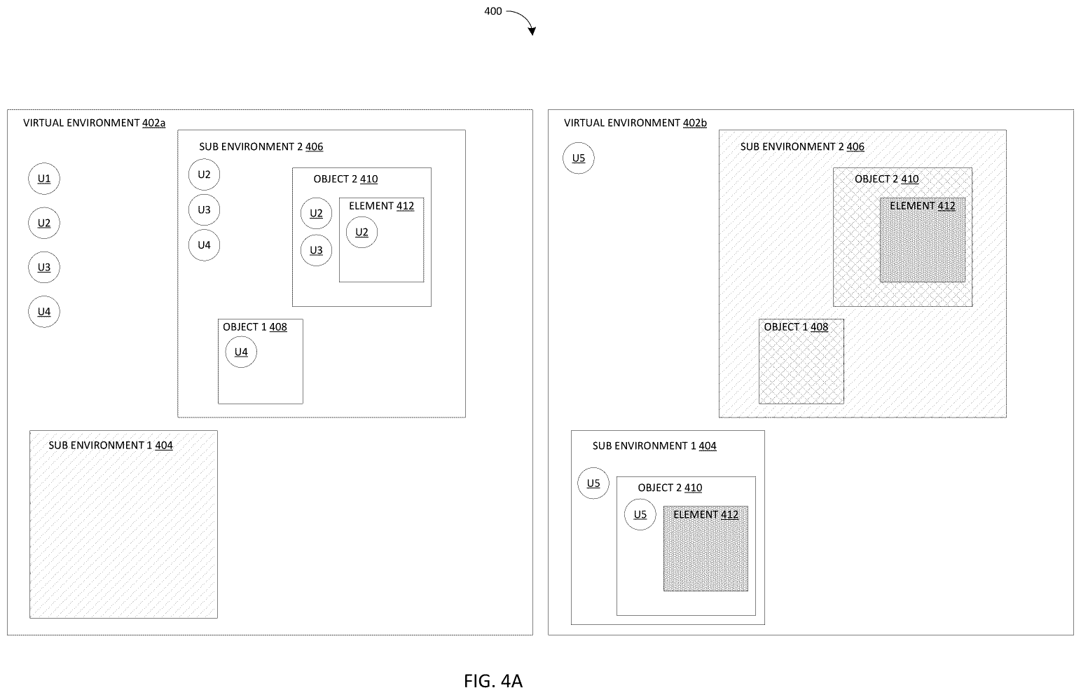

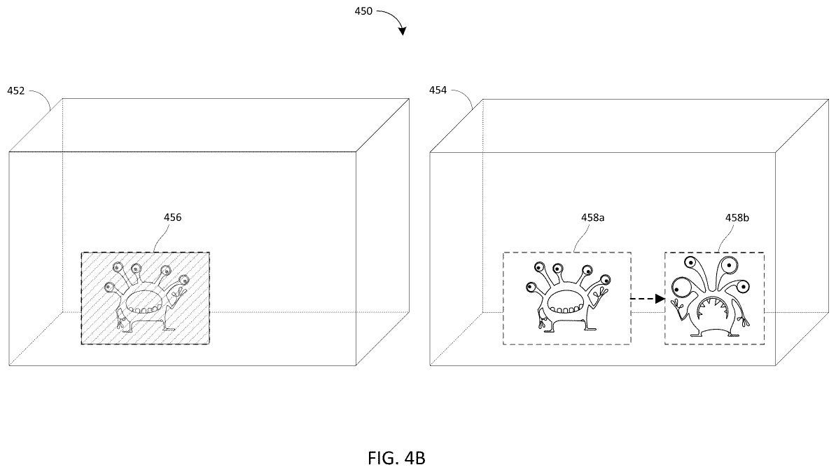

FIG. 4A and FIG. 4B illustrate embodiments of instantiation of multiple editor session for editing a game application at the same time. Referring to FIG. 4A, editor sessions 400 illustrate a graphical representation of two editor sessions that are configured to view/editing the same game data in parallel. Editor session 400 provides a graphical representation of locked game data as described with respect to FIG. 1B. In the illustrated example, virtual environment 402a and virtual environment 402b comprise an instantiated view of the same game data. Users U1-U4 are connected to an editing session associated with virtual environment 402a while user U5 is connected to an editing session associated with virtual environment 402b. The editing permissions of users U1-U5 are illustrated in the same manner as described with respect to FIG. 3A.

In the illustrated example, user U2 may be actively editing sub environment 406 and element 412 in virtual environment 402a, thereby locking sub environment 406 and element 412. Sub environment 406 and element 412 can be locked in virtual environment 402b and visual updates to the Sub environment 406 can be suspended until the edit is complete. User U5 cannot edit sub environment 406 or element 412 in virtual environment 402b or see the changes that user U2 makes. Rather, sub environment 406 and element 412 are frozen in the virtual environment 402b in a state each was prior to user U2 beginning edits until user U2 has committed any changes. Similarly, user U5 may be editing sub environment 404 in virtual environment 402b, thereby locking sub environment 404 in virtual environment 402a. In one embodiment user, U2 and user U5 can make edits simultaneously.

In the illustrated embodiment, element 412 can be a subset of the game data associated with object 410, or another form of game data, used in object 410. In contrast, object 410 is not dependent game data for sub environments 404 and 406. As such, user U1 editing object 410 found in sub environment 406 may not lock object 410 found in sub environment 404. However, because element 412 is dependent game data for object 410, user U1 editing element 412 will lock all instances of 412 in object 410. As such, user U5 can edit all the game data of object 410 except element 412.

Referring to FIG. 4B, editor sessions 450 illustrate an example of virtual environment 452 and virtual environment 454 used to view and edit the same set of game data. In the illustrated embodiment, objects 456, 458a, and 458b represent the same object of game data (e.g., an alien character object in a game application). Object 456 represents the alien character in virtual environment 452. Objects 458a and 458b represent the alien character in virtual environment 454 at different points in time. In the illustrated embodiment, a user initiated editing the alien character in virtual environment 454. In the example, the user edited the alien character such that the alien character has gone from appearing as object 458a to appearing as object 458b, but the user has not committed any changes to the alien character. In the example, users in virtual environment 454 may view the changes to the alien character as they were made in real time. In contrast, any user in virtual environment 452 may view a locked and frozen object 456. In some embodiments, an object appears in the same state until the user finished editing the object. In some embodiments, the object may have a visual indication, such as it can appear greyed or blacked out in virtual environment 452, until changes are committed in virtual environment 454.

### Process for Managing Editor Session

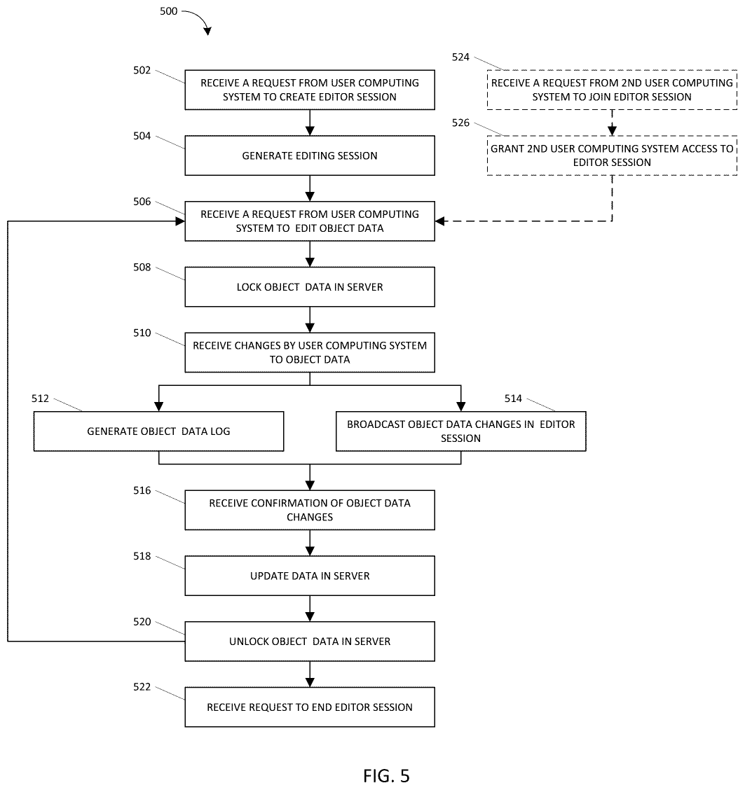

FIG. 5 illustrates an embodiment of a flowchart of process 500 for managing an editor session using an interactive computing system 130. The processes, in whole or in part, can be implemented by CPUs and/or GPUs configured with computer readable instructions to execute an editor session 154 on a server (e.g., interactive computing system 130) communicating with a client (e.g., user computing system 102) over a network 120. For example, the processes, in whole or in part, can be implemented by the interactive computing system 130, asset library 136, data view explorer 134, account data store 140, game data store 138, and game editor client 110. Although any number of systems, in whole or in part, can implement the processes, to simplify discussion, the processes will be described with respect to the interactive computing system 130 and components thereof.

At block 502, the interactive computing system 130 receives a request from a user computing system 102 to create an editing sessions 154. The request can come from the game editor client 110 executing on the user computing system 102. In some embodiments, the request may come from another application on the user computing system 102, such as a browser application. In some embodiments, the browser application may be instructed to initiate a download of the game editor client 110 in order to continue the process of editing the game data. In some embodiments, the browser application may function as the game editor client 110 for at least a portion of the process 500. The request can include user account credentials and login information associated with the user. The user can log in on the game editor client 110 and can establish communication with the interactive computing system 130. The request can identify a game application for which the user is requesting to edit. In some embodiments, the user may select the option to create an editing session from data provided to the user by the data view explorer 134.

At block 504, the interactive computing system 130 generates an editing session. The process can include the processes for generating an editing sessions 154 as described with respect to FIG. 1B. For example, generating an editing session may include creating an instantiated data view 152 of the game data from the game data store 138 and loading tools and other game assets via the asset library 136. Generating an editing session may also include accessing user account information from the user account data store 140.

At block 524, optionally, the interactive computing system 130 may receive a request from a second user computing system to join the editor session. For example, the second user computing system 102 may interact with the data view explorer 134 through the game editor client 110 to select the editor session 154. In some embodiments, the interactive computing system 130 loads the user account information from the user account data store 140 associated with the second user computing system 102.

At optional block 526, the interactive computing system 130 grants access to the second user computing system to access the editor session. For example, the interactive computing system 130 may review the user account information associated with the second user computing system 102 and determine the second user has the required permissions to join the editor session 154. If the second user computing system 102 has the required permissions to join the editor session 154, the interactive computing system 130 may configure the editor session 154 so that the second user can view and edit the instantiated data view 152 of the game data.

At block 506, the interactive computing system 130 receives a request from a user computing system to edit object data. For example, a user computing system 102 may interact with the editor session 154 through the game editor client 110 to select object data (e.g., game data such as object 354 of FIG. 3B) to edit. The interactive computing system may map the object data to game data stored in the game data store 138.

At block 508, the interactive computing system 130 locks the object data in the server. For example, the interactive computing system 130 may flag the game data stored in the game data store 138 that was previously mapped to the object data. The flagged game data may prevent the interactive computing system 130 from allowing the same game data to be changed until the flag is removed.

At block 510, the interactive computing system 130 receives changes by a user computing system to the object data. For example, a user computing system 102 may interact with the editor session 154 through the game editor client 110 to use one or more game editor tools 108 to alter the object data. The game editor tools 108 available to the user computing system 102 may be dependent on the type of game data the object data is, the type of editor session the user computer system 102 is connected to, the permission the user computing system 102 is associated with, and/or the type of tools the user computing system 102 has installed. The user computing system 102 can make changes to the object data.

At block 512, the interactive computing system 130 generates an object data log. For example, the interactive computing system 130 may create and store a log of every change such as the datalogs 204 discussed in FIG. 2. The data logs may track all the changes to the object data including nonfinal changes to the object data. The interactive computing system 130 may store the datalogs 204 in the game data store 138.

At block 514, the interactive computing system 130 updates the object data changes within the editor session. For example, the interactive computing system 130 may cache changes to the object data and update the object data in the instantiated data view 152 such that all user computing systems 102 connected to the editor session 154 may receive live updates to the changes made to the object data.

At block 516, the interactive computing system 130 receives a confirmation of object data changes. For example, a user computing system 102 may interact with the editor session 154 through the game editor client 110 to confirm the changes to the object data. The user computing system 102 may be signaling that the changes to the object data are final and should be committed to the game data store 138.

At block 518, the interactive computing system 130 updates the game data in the server. For example, interactive computing system 130 may update the flagged game data stored in the game data store 138 to the final version of the object data.

At block 520, the interactive computing system 130 unlocks the object data in the server. For example, the interactive computing system 130 may remove the flag on the game data stored in the game data store 138 that was previously mapped to the object data. By removing the flag, the interactive computing system 130 may allow the object data to be changed in the same or other editor sessions 154. From block 520, the interactive computing system 130 may receive another request from a user computing system to edit object data and return to block 506. Alternatively, the interactive computing system 130 may proceed to block 522.

At block 522, the interactive computing system 130 receives a request to end the editor session. For example, a user computing system 102 may interact with the editor session 154 through the game editor client 110 to indicate that the editor session 154 is to be closed. The interactive computing system 130 may terminate the instantiated data view 152 and halt streaming some, or all data to the user computing system 102 via the game development server 132 and/or the data view explorer 134. In some embodiments, the editor session is removed from the data view explorer 134 for other user computing system 102 to select. An editor session may not end until all users are disconnected from the instantiated data view 152. Prior to termination of the editor session, users may connect or disconnect from the editor session while other users are still connected to the editor session. The interactive computing system 130 may terminate an instantiated data view 152 when the last user disconnects from the instantiated data view 152. In some embodiments, the interactive computing system 130 does not terminate the instantiated data view 152 unless a specific request is received to end the editor session. For example, the interactive computing system 130 may leave an instantiated data view 152 open with no users connected unless the interactive computing system 130 receives a request from a user computing system 102 to end the editor session.

### Process for User to Edit Game Data

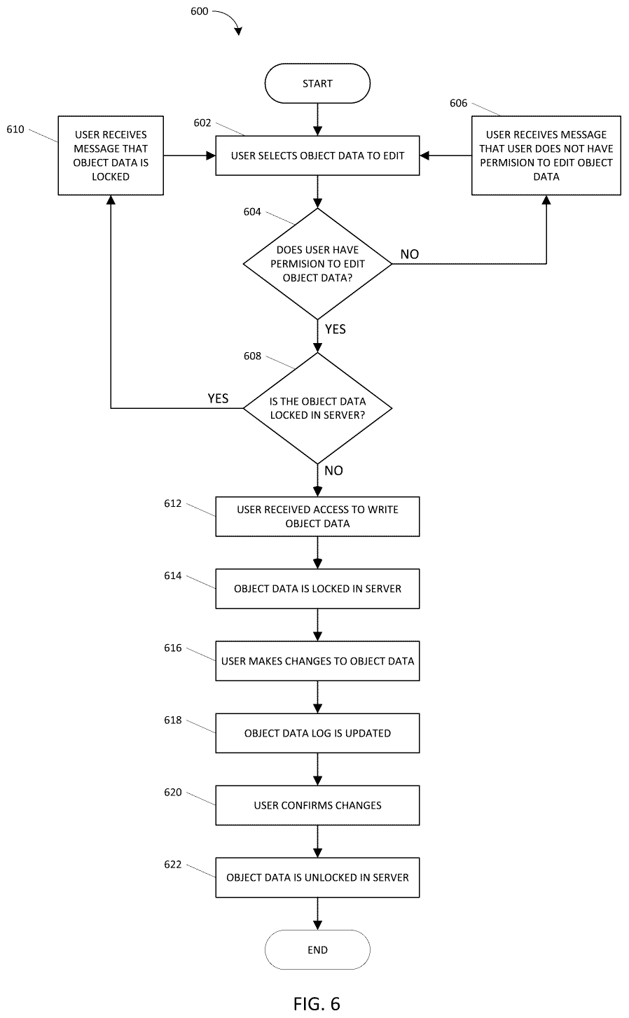

FIG. 6 illustrates an embodiment of a flowchart of process 600 for editing game data using a game editor client 110 of a user computing system 102. The processes, in whole or in part, can be implemented by CPUs and/or GPUs configured with computer readable instructions to execute an editor client 110 on a user device (e.g., user computing system 102) communicating with a server (e.g., interactive computing system 130) over a network 120. For example, the processes, in whole or in part, can be implemented by the interactive computing system 130, data view explorer 134, account data store 140, game data store 138, and game editor client 110. Although any number of systems, in whole or in part, can implement the processes, to simplify discussion, the processes will be described with respect to the user computing system 102 and components thereof.

At block 602, the user computing system 102 selects object data to edit. For example, a user may select object data using the game editor client 110. The game editor client 110 may be connected to an editor session 154 of an interactive computing system 130. The object data may be a game application, a portion of a game application, a game asset, and/or any other data associated with game development described herein.

At block 604, the user computing system 102 determines whether the user has permission to edit the object data. For example, the user computing system 102 may access user account information from the application data store 106. Alternatively, the 102 may stream the user account information from the account data store 140 of the interactive computing system 130 via the network 120. If the user computing system 102 determines the user does not have the permission to edit the object data, the user computing system proceeds to block 606. If the user computing system 102 determines the user has the permission to edit the object data, the user computing system proceeds to block 608.

At block 606, the user computing system 102 displays a message to the user that the user does not have the permission to edit the object data. For example, a textual message may appear on a display of the user computing system 102. Alternatively, a nonverbal message may communicate that the user does not have permission to edit the object. For example, a color signal (e.g., the object data appears red or greyed out) or an audio signal (e.g., a specific audio file is played through an audio peripheral of the user computing system 102). The above examples are not meant to limit the form of the message to the user and any message configured to communicate to the user that does not have permission to edit the object data may be used where appropriate.

At block 608, the user computing system 102 determines if the object data is locked in the server. For example, the user computing system 102 may send a request to edit the object data to the interactive computing system 130 through the game editor client 110. The interactive computing system 130 may check to see if the object data is locked. For example, the interactive computing system 130 may check to see if the object data is associated with flagged game data as described with reference to FIG. 5. If the interactive computing system 130 finds the game data is locked, the interactive computing system 130 may provide an indication to the user computing system 102 that the object data is locked. Alternatively, if the interactive computing system 130 finds the game data is not locked, the interactive computing system 130 may provide an indication to the user computing system 102 that the object data is not locked. The user computing system 102 may use the indication from the 130 to determine whether the object data is locked in the server. If the user computing system 102 determines the object data is locked in the server, the user computing system 102 proceeds to block 610. If the user computing system 102 determines the object data is not locked in the server, the user computing system 102 proceeds to block 612.

At block 610, the user computing system 102 displays a message to the user that the object data is locked. For example, a textual message may appear on a display of the user computing system 102. Alternatively, a nonverbal message may communicate to the user that the object data is locked. For example, the user computing system 102 may use a color signal (e.g., the object data appears red or greyed out) or an audio signal (e.g., a specific audio file is played through an audio peripheral of the user computing system 102). The above examples are not meant to limit the form of the message to the user and any message configured to communicate to the user that the object data is locked may be used where appropriate.

At block 612, the user computing system 102 receives access to write to the object data. For example, user computing system 102 may send a request to edit the object data to the interactive computing system 130. The interactive computing system 130 may map the object data to game data in the game data store 138. The mapped data may allow a user to make changes to object data through the game editor client and effectuate the same changes to the game data in the game data store 138.

At block 614, the user computing system 102 locks the object data in the server. For example, the user computing system 102 may send a request to edit the object data to the interactive computing system 130. The interactive computing system 130 may search for any game data that has been mapped to the object data and lock the game data. For example, the interactive computing system 130 may flag game data that has been mapped to the object data. While blocks 612 and 614 have been described as two distinct processes, the process may be performed together. For example, the user computing system 102 may only send one request to edit the object data and the interactive computing system 130 may map and flag the data in response to the request.

At block 616, the user computing system 102 makes changes to the object data. For example, the user computing system 102 may update and/or change the object data through the game editor client 110 using one or more game editor tools 108. The user computing system 102 may make the changes to the object data on temporary copies of the object data that have been downloaded to the user computing system 102 or on data that is stored on the interactive computing system (e.g., on the game data store 138). The changes to the object data may not be permanent. For example, the game data in the game data store 138 that is mapped to the object data may remain unchanged while changes to the object data are taking place.

At block 618, the user computing system 102 update the object data log. For example, the user computing system 102 may create a data log of all changes to the object data. In some embodiments, the 102 sends all changes to the object data to the interactive computing system 130 for the changes to be updated in a datalog 204 as discussed with reference to FIG. 2.

At block 620, the user computing system 102 confirms the changes to the object data. For example, the user computing system 102 may confirm the changes with the interactive computing system 130 through the game editor client 110. The interactive computing system 130 may receive a final version of object data and any data logs stored locally on the user computing system 102. The interactive computing system 130 may update the game data in the game data store 138 to reflect the changes in the object data. The interactive computing system 130 may also update any datalogs 204 in the game data store 138 to include any data logs that were previously stored locally on the user computing system 102. The object data can remain locked as the user iteratively loops through the update process (e.g., block 616, block 618, and block 620) for the object data. For example, the process may perform block 616, block 618, and block 620 multiple times and allow a user to make multiple changes to the object data before the process proceeds to block 622 and the object data is unlocked.

At block 622, the user computing system 102 unlocks the object data in the server. For example, the user computing system 102 may cause the interactive computing system 130 may unlock any game data associated with the object data. In some embodiments, once data is unlocked, other user computing systems 102 connected to the interactive computing system 130 may access and/or change the game data associated with the object data.

### Overview of Computing Device

FIG. 7 illustrates an embodiment of user computing system 102 according to the present disclosure. Other variations of the user computing system 102 may be substituted for the examples explicitly presented herein, such as removing or adding components to the user computing system 102. The user computing system 102 may include a game device, a smart phone, a tablet, a personal computer, a laptop, a smart television, a car console display, a server, and the like. As shown, the user computing system 102 includes a processing unit 20 that interacts with other components of the user computing system 102 and also external components to user computing system 102. A media reader 22 is included that communicates with media 12. The media reader 22 may be an optical disc reader capable of reading optical discs, such as CD-ROM or DVDs, or any other type of reader that can receive and read data from game media 12. One or more of the computing devices may be used to implement one or more of the systems disclosed herein.

User computing system 102 may include a separate graphics processor 24. In some cases, the graphics processor 24 may be built into the processing unit 20. In some such cases, the graphics processor 24 may share Random Access Memory (RAM) with the processing unit 20. Alternatively, or in addition, the user computing system 102 may include a discrete graphics processor 24 that is separate from the processing unit 20. In some such cases, the graphics processor 24 may have separate RAM from the processing unit 20. User computing system 102 might be a handheld video game device, a dedicated game console computing system, a general-purpose laptop or desktop computer, a smart phone, a tablet, a car console, or other suitable system.

User computing system 102 also includes various components for enabling input/output, such as an I/O 32, a user I/O 34, a display I/O 36, and a network I/O 38. I/O 32 interacts with storage element 40 and, through a device 42, removable storage media 44 in order to provide storage for user computing system 102. Processing unit 20 can communicate through I/O 32 to store data, such as game state data and any shared data files. In addition to storage 40 and removable storage media 44, user computing system 102 is also shown including ROM (Read-Only Memory) 46 and RAM 48. RAM 48 may be used for data that is accessed frequently, such as when a game is being played or the fraud detection is performed.

User I/O 34 is used to send and receive commands between processing unit 20 and user devices, such as game controllers. In some embodiments, the user I/O can include a touchscreen input. The touchscreen can be capacitive touchscreen, a resistive touchscreen, or other type of touchscreen technology that is configured to receive user input through tactile inputs from the user. Display I/O 36 provides input/output functions that are used to display images from the game being played. Network I/O 38 is used for input/output functions for a network. Network I/O 38 may be used during execution of a game, such as when a game is being played online or being accessed online and/or application of fraud detection, and/or generation of a fraud detection model.

Display output signals produced by display I/O 36 comprising signals for displaying visual content produced by user computing system 102 on a display device, such as graphics, user interfaces, video, and/or other visual content. User computing system 102 may comprise one or more integrated displays configured to receive display output signals produced by display I/O 36. According to some embodiments, display output signals produced by display I/O 36 may also be output to one or more display devices external to user computing system 102.

The user computing system 102 can also include other features that may be used with a game, such as a clock 50, flash memory 52, and other components. An audio/video player 56 might also be used to play a video sequence, such as a movie. It should be understood that other components may be provided in user computing system 102 and that a person skilled in the art will appreciate other variations of user computing system 102.

Program code can be stored in ROM 46, RAM 48 or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media such as game media 12 (which can be a CD-ROM, cartridge, memory chip or the like, or obtained over a network or other electronic channel as needed). In general, program code can be found embodied in a tangible non-transitory signal-bearing medium.

Random access memory (RAM) 48 (and possibly other storage) is usable to store variables and other game and processor data as needed. RAM is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the user computing system 102 is turned off or loses power.

As user computing system 102 reads media 12 and provides an application, information may be read from game media 12 and stored in a memory device, such as RAM 48. Additionally, data from storage 40, ROM 46, servers accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A method for collaboratively editing game data of a game application within a virtual development space, the method comprising:
receiving a request from a user computing system to initiate an editing session;
creating an instantiated virtual development space, wherein the instantiated virtual development space enables a first plurality of game developer systems to view and edit game data, and wherein the game data is stored on a server;
receiving a request from a first game developer system of the first plurality of game developer systems to edit a first set of game data, wherein the first set of game data is a temporary instantiation of a subset of the game data;
locking the subset of the game data in the server;
receiving one or more changes by the first game developer system to the first set of game data;
generating a log tracking the one or more changes to the first set of game data;
broadcasting the one or more changes to the first set of game data within the instantiated virtual development space such that updates of the first set of game data are visible to the first plurality of game developer systems;
receiving a change confirmation by the first game developer system for the one or more changes resulting in a confirmed change to the first set of game data;
updating the subset of the game data in the server such that the subset of the game data in the server includes the confirmed change to the first set of game data; and
unlocking the subset of the game data in the server.

2. The method of claim 1, the method further comprising:
receiving a request from a second user computing system to initiate a second editing session; and
creating a second instantiated virtual development space, wherein the second instantiated virtual development space enables a second plurality of game developer systems to view and edit the game data.

3. The method of claim 2, the method further comprising, in response to locking the subset of the game data in the server, preventing the second plurality of game developer systems from requesting to edit a second set of game data, wherein the second set of game data is a temporary instantiation of the subset of the game data.

4. The method of claim 3, the method further comprising, in response to unlocking the subset of the game data in the server, broadcasting the one or more changes to the first set of game data within the second instantiated virtual development space such that the confirmed change to the first set of game data is visible to the second plurality of game developer systems.

5. The method of claim 1, wherein the first game developer system receives permission from the server prior to making a request to edit the first set of game data.

6. The method of claim 1, wherein creating the instantiated virtual development space comprises delivering one or more data editing tools to the first plurality of game developer systems, wherein the one or more editing tools are configured to enable the first plurality of game developer systems to view and edit the game data.

7. The method of claim 1, wherein, in response to locking the subset of the game data in the server, a second game developer system of the first plurality of game developer systems is prevented from editing the first set of game data.

8. The method of claim 7, further comprising receiving permission from the first game developer system to allow the second game developer system to edit the first set of game data.

9. A system for collaboratively editing game data of a game application within a virtual development space, the system comprising:
one or more processors configured with computer executable instructions that configure the one or more processors to:
receive a request from a user computing system to initiate an editing session;
create an instantiated virtual development space, wherein the instantiated virtual development space enables a first plurality of game developer systems to view and edit game data, and wherein the game data is stored on a server;
receive a request from a first game developer system of the first plurality of game developer systems to edit a first set of game data, wherein the first set of game data is a temporary instantiation of a subset of the game data;
lock the subset of the game data in the server;
receive one or more changes by the first game developer system to the first set of game data;
generate a log tracking the one or more changes to the first set of game data;
broadcast the one or more changes to the first set of game data within the instantiated virtual development space such that updates of the first set of game data are visible to the first plurality of game developer systems;
receive a change confirmation by the first game developer system for the one or more changes resulting in a confirmed change to the first set of game data;
update the subset of the game data in the server such that the subset of the game data in the server includes the confirmed change to the first set of game data; and
unlock the subset of the game data in the server.

10. The system of claim 9, wherein the one or more processors are further configured to:
receive a request from a second user computing system to initiate a second editing session; and
create a second instantiated virtual development space, wherein the second instantiated virtual development space enables a second plurality of game developer systems to view and edit the game data.

11. The system of claim 10 wherein the one or more processors are further configured to:
in response to locking the subset of the game data in the server, prevent the second plurality of game developer systems from requesting to edit a second set of game data, wherein the second set of game data is a temporary instantiation of the subset of the game data.

12. The system of claim 11, wherein the one or more processors are further configured to:
in response to unlocking the subset of the game data in the server, broadcast the one or more changes to the first set of game data within the second instantiated virtual development space such that the confirmed change to the first set of game data is visible to the second plurality of game developer systems.

13. The system of claim 9, wherein the first game developer system receives permission from the server prior to making a request to edit the first set of game data.

14. The system of claim 9, wherein the one or more processors are further configured to create the instantiated virtual development space comprises delivering one or more data editing tools to the first plurality of game developer systems, wherein the one or more editing tools are configured to enable the first plurality of game developer systems to view and edit the game data.

15. A non-transitory computer readable medium comprising computer-executable instructions for collaboratively editing game data of a game application within a virtual development space that, when executed by at least one processor of a computing system, causes the computing system to:
receive a request from a user computing system to initiate an editing session;
create an instantiated virtual development space, wherein the instantiated virtual development space enables a first plurality of game developer systems to view and edit game data, and wherein the game data is stored on a server;
receive a request from a first game developer system of the first plurality of game developer systems to edit a first set of game data, wherein the first set of game data is a temporary instantiation of a subset of the game data;
lock the subset of the game data in the server;
receive one or more changes by the first game developer system to the first set of game data;
generate a log tracking the one or more changes to the first set of game data;
broadcast the one or more changes to the first set of game data within the instantiated virtual development space such that updates of the first set of game data are visible to the first plurality of game developer systems;
receive a change confirmation by the first game developer system for the one or more changes resulting in a confirmed change to the first set of game data;
update the subset of the game data in the server such that the subset of the game data in the server includes the confirmed change to the first set of game data; and
unlock the subset of the game data in the server.

16. The non-transitory computer readable medium of claim 15, wherein the computer-executable instructions further configure the computing system to:
receive a request from a second user computing system to initiate a second editing session; and
create a second instantiated virtual development space, wherein the second instantiated virtual development space enables a second plurality of game developer systems to view and edit the game data.

17. The non-transitory computer readable medium of claim 16, wherein the computer-executable instructions further configure the computing system to:
in response to locking the subset of the game data in the server, prevent the second plurality of game developer systems from requesting to edit a second set of game data, wherein the second set of game data is a temporary instantiation of the subset of the game data.

18. The non-transitory computer readable medium of claim 17, wherein the computer-executable instructions further configure the computing system to:
in response to unlocking the subset of the game data in the server, broadcast the one or more changes to the first set of game data within the second instantiated virtual development space such that the confirmed change to the first set of game data is visible to the second plurality of game developer systems.

19. The non-transitory computer readable medium of claim 15, wherein, in response to locking the subset of the game data in the server, a second game developer system of the first plurality of game developer systems is prevented from editing the first set of game data.

20. The non-transitory computer readable medium of claim 19, wherein the computer-executable instructions further configure the computing system to receive permission from the first game developer system to allow the second game developer system to edit the first set of game data.
